(19) United States
(12) Patent Application Publication
(10) Pub. No.: US 2016/0039630 A1
(43) Pub. Date: Feb. 11, 2016

(54) SHEET CONVEYING APPARATUS AND IMAGE FORMING APPARATUS

(71) Applicant: CANON KABUSHIKI KAISHA, Tokyo (JP)

(72) Inventor: Masataka Fumoto, Tokyo (JP)

(21) Appl. No.: 14/816,144

(22) Filed: Aug. 3, 2015

(30) Foreign Application Priority Data
Aug. 8, 2014 (JP) 2014-162456
Jul. 30, 2015 (JP) 2015-151150

(51) Int. Cl. B65H 37/00; B65H 5/06; B08B 1/00; B65H 7/02

(52) U.S. Cl. CPC B65H 37/00; B65H 7/02; B65H 5/062; B65H 5/068; B08B 1/006; B65H 2220/01

(57) ABSTRACT

In response to an arrival of a first cleaning region of the cleaning sheet to a pre-registration roller pair, a control portion drives the pre-registration roller pair for a predetermined time and cleans the pre-registration roller pair by the first cleaning region by stopping a fed sheet drawing roller pair and a registration roller pair. Then, after an elapse of the predetermined time, as the cleaning sheet is conveyed and a second cleaning region of the cleaning sheet arrives at the registration roller pair, the control portion cleans the registration roller pair by the second cleaning region.

### BACKGROUND OF THE INVENTION

1. Field of the Invention

The present invention relates to a sheet conveying apparatus configured to convey a sheet and to an image forming apparatus.

2. Description of the Related Art

Hitherto, an image forming apparatus such as a copier forming an image on a sheet, e.g., a printing paper, is configured to convey the sheet delivered out of a sheet feeding cassette to an image forming portion and to convey and discharge the sheet onto which the image has been formed to a sheet stacking portion. The image forming apparatus includes a sheet conveying apparatus including a plurality of conveying roller pairs for conveying the sheet. Some of such sheet conveying apparatuses are configured to correct a skew of the sheet by a registration roller pair just before conveying the sheet, delivered out of the sheet feed cassette by a pickup roller pair, to the image forming portion. Geometric characteristics of the image are thus improved by correcting the skew of the sheet in conveying the sheet by the registration roller pair.

By the way, there is a case when paper dust is generated from the sheet in conveying the sheet, and if foreign matters such as the paper dust and dust within the apparatus adhere on a surface of the conveying roller pair, an apparent coefficient of friction of the conveying roller pair drops and a sheet nipping and conveying force of the conveying roller pair drops. Conventionally, sheet-nipping pressure of a conveying roller pair is set such that the pressure of a conveying roller pair located upstream of a registration roller pair is lighter in general based on the registration roller pair.

Therefore, the conveying roller pair located upstream of the registration roller pair is liable to be more influenced by the drop of the coefficient of friction. For instance, if a conveying path located upstream of the registration roller pair bends and a coefficient of friction of a conveying roller pair disposed within this bent conveying path drops, there is a case where resistance of a front end of the sheet receiving from the conveying path exceeds the sheet-nipping force. In this case, the sheet is not conveyed by the conveying roller pair, causing such a problem that the sheet is jammed within the conveying path.

Then, conventionally, Japanese Patent Application Laid-open No. 2012-139845 for example proposes such an arrangement that in a state in which a sheet for use in cleaning the conveying roller pair (referred to simply as a ‘cleaning sheet’ hereinafter) is held by a holding portion, a driving roller pair is rotated in a direction in which the sheet separates from the holding portion so that the driving roller pair slips with respect to the sheet. This arrangement makes it possible to remove foreign matters adhering on the surface of the roller.

The sheet conveying apparatus disclosed in Japanese Patent Application Laid-open No. 2012-139845 described above, is also configured such that after cleaning the surface of the upstream conveying roller pair for example by the cleaning sheet, the cleaning sheet is conveyed to a downstream conveying roller pair to remove foreign matters adhering on the downstream conveying roller pair. However, in removing the foreign matters adhering on the surface of the downstream conveying roller pair, there is concern that the foreign matters removed from the upstream conveying roller pair by the cleaning sheet adhere again on the downstream conveying roller pair if the downstream conveying roller pair is slipped in a cleaning region of the cleaning sheet by which the foreign matters adhering on the surface of the upstream conveying roller pair has been removed.

### SUMMARY OF THE INVENTION

According to one aspect of the invention, a sheet conveying apparatus includes a first conveying roller pair driven by a first driving portion, a second conveying roller pair provided downstream in a sheet conveying direction of the first conveying roller pair and driven by a second driving portion, a third conveying roller pair provided downstream in the sheet conveying direction of the second conveying roller pair and driven by a third driving portion, a cleaning sheet including a first cleaning region for cleaning the second conveying roller pair and a second cleaning region, different from the first cleaning region, for cleaning the third conveying roller pair, and a control portion controlling the first, second and third driving portions. The control portion controls the first and second driving portions such that a sheet conveying speed of the second conveying roller pair is faster than a sheet conveying speed of the first conveying roller pair for a first predetermined time in response to an arrival of the first cleaning region of the cleaning sheet being conveyed by the first and second conveying roller pairs at the second conveying roller pair and controls after an elapse of the first predetermined time, the second and third driving portions such that a sheet conveying speed of the third conveying roller pair is faster than the a sheet conveying speed of the second conveying roller pair for a second predetermined time in response to an arrival of the second cleaning region of the cleaning sheet being conveyed by the second and third conveying roller pairs at the third conveying roller pair.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a printer, i.e., one exemplary image forming apparatus, including a sheet conveying apparatus of a first embodiment of the invention.

FIG. 2 is a diagram explaining a cleaning operation of a pre-registration roller pair by a cleaning sheet of the sheet conveying apparatus.

FIG. 3 is a control block diagram of the sheet conveying apparatus.

FIG. 4A is a diagram illustrating a state before a first cleaning region of the cleaning sheet arrives at a nip portion of the pre-registration roller pair.

FIG. 4B is a diagram illustrating a state in which the first cleaning region of the cleaning sheet arrives at the nip portion of the pre-registration roller pair.

FIG. 4C is a diagram illustrating a state in which the pre-registration roller pair is cleaned by the first cleaning region of the cleaning sheet.

FIG. 5 is a timing chart illustrating drive controls of the pre-registration roller pair and others during the cleaning operation of the pre-registration roller pair.

FIG. 6A is a diagram illustrating a state before a second cleaning region of the cleaning sheet arrives at a nip portion of the registration roller pair.

FIG. 6B is a diagram illustrating a state in which the second cleaning region of the cleaning sheet arrives at the nip portion of the registration roller pair.

FIG. 6C is a diagram illustrating a state in which the registration roller pair is cleaned by the second cleaning region of the cleaning sheet.

FIG. 7 is a timing chart illustrating drive controls of the pre-registration roller pair and others during the cleaning operation of the registration roller pair.

FIG. 8 is a diagram illustrating a cleaning operation of a sheet conveying apparatus of a second embodiment of the invention.

FIG. 9 is a diagram illustrating a cleaning operation of a sheet conveying apparatus of a third embodiment of the invention.

### DESCRIPTION OF THE EMBODIMENTS

### First Embodiment

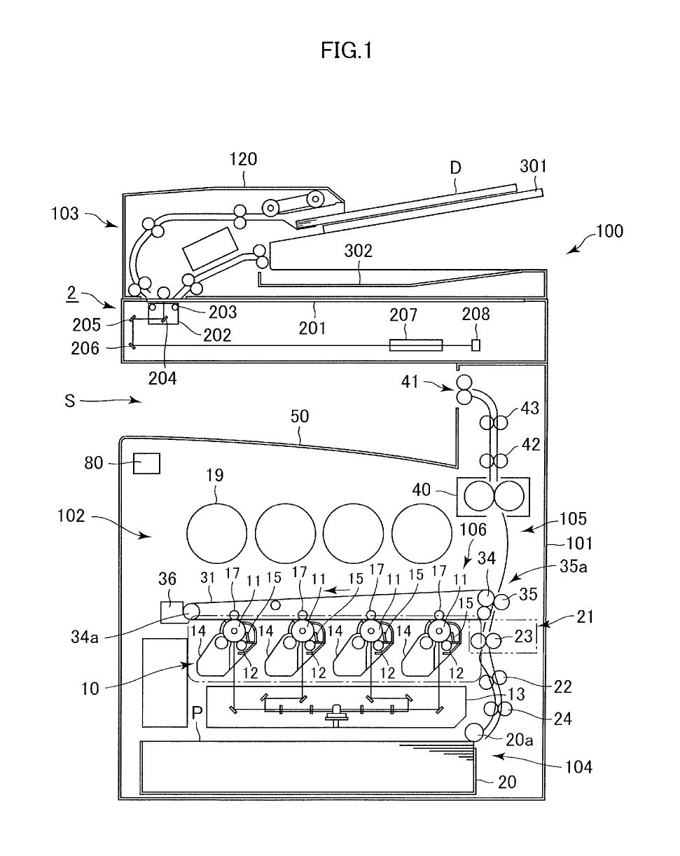

Embodiments of the invention will be described in detail below with reference to the drawings. FIG. 1 is a diagram schematically illustrating a configuration of a printer, i.e., an exemplary image forming apparatus including a sheet conveying apparatus of a first embodiment of the invention. In FIG. 1, the printer 100 includes a printer body 101 including an image forming portion 102 and others. Provided at an upper part of the printer body 101 is an image reading apparatus 103 reading a document D placed by an automatic document conveying apparatus 120 on a platen glass 201, i.e., a document placing table. A sheet discharging space S for sheet discharging is formed between the image reading apparatus 103 and the printer body 101.

It is noted that a sheet feeding apparatus 104 is provided at a lower part of the printer body 101. A sheet fed by the sheet feeding apparatus 104 is conveyed by a sheet conveying apparatus 105 to the image forming portion 102 and, after formation of an image in the image forming portion 102, to a sheet discharging roller pair 41. Then, the sheet on which the image has been formed is discharged by the sheet discharging roller pair 41 to the sheet discharging space S. It is noted that an image forming operation of the image forming portion 102, the sheet conveying operation and others of the sheet conveying apparatus 105, are controlled by a body control portion 80, i.e., a control portion.

The image forming portion 102 is of a four-drum full-color type and includes the laser scanner 13, four process cartridges 10 forming four color toner images of yellow (Y), magenta (M), cyan (C), and black (K). Here, each of the process cartridges 10 includes a photosensitive drum 11, a charging roller 12, i.e., a charging means, a developing unit 14, i.e., a developing means, and a cleaner 15. The image forming portion 102 also includes a toner cartridge 19 and an intermediate transfer unit 106 provided above the process cartridges 10.

The intermediate transfer unit 106 includes an intermediate transfer belt 31 wrapped around a secondary transfer inner roller 34, a tension roller 34a, and others and rotating in a direction of an arrow. The intermediate transfer unit 106 also includes primary transfer rollers 17 provided inside of the intermediate transfer belt 31 and are in contact with the intermediate transfer belt 31 at positions facing the photosensitive drums 11.

Then, the respective negative color toner images on the photosensitive drums are sequentially superimposed and transferred onto the intermediate transfer belt 31 as positive transfer bias is applied to the intermediate transfer belt 31 by the primary transfer rollers 17. A secondary transfer outer roller 35 constituting a secondary transfer portion transferring the color image formed onto the intermediate transfer belt 31 to the sheet P is provided at a position facing a secondary transfer inner roller 34 of the intermediate transfer unit 106. Still further, a fixing portion 40 is disposed above the secondary transfer portion, and inner sheet discharging roller pairs 42 and 43 and a sheet discharging roller pair 41 are disposed above the fixing portion 40. It is noted that the secondary transfer inner roller 34 and the secondary transfer outer roller 35 will be referred to as a secondary transfer roller pair 35a hereinafter.

Next, an image forming operation of the printer 100 constructed as described above will be described below. At first, an image reading apparatus 103 feeds documents D set upward on a document tray 301 sequentially one by one from an uppermost document by an automatic document conveying apparatus 120. Then, the image reading apparatus 103 passes the document D onto the platen glass 201 through a curved path and then discharges on a sheet discharging tray 302. A scanner unit 202 held at a predetermined position performs an image reading process on the document D passing on the platen glass 201 from a left side to a right side. Specifically, a surface of the document D to be read is irradiated by light of the lamp 203 of the scanner unit 202, and reflection light from the document D is lead to mirrors 204, 205 and 206 through a lens 207. The light that has passed through the lens 207 is formed on an image pickup face of an image sensor 208, is transmitted by being converted into an electrical digital signal.

After being subject to image processing, this digital signal is converted into an electrical signal and is transmitted to a laser scanner 13 of the image forming portion 102. It is noted that there is also a case where image information is inputted to the image forming portion 102 from an external device such as a personal computer not shown. Then, in the image forming portion 102, surfaces of the respective photosensitive drums 11 of the process cartridges 10 are scanned by laser lights corresponding to the image information of the respective component colors of yellow, magenta, cyan, and black emitted from the laser scanner 13. Thereby, the surfaces of the photosensitive drums 11 homogeneously electrified with predetermined polarity and potential by the charging roller 12 are sequentially exposed, and electrostatic latent images of yellow, magenta, cyan, and black are formed, respectively, on the photosensitive drums 11 of the process cartridges 10.

After that, the image forming portion 102 visualizes the electrostatic latent images by developing by the developing unit 14 by using toners of yellow, magenta, cyan, and black and applies primary transfer bias to the primary transfer rollers 17. Thereby, the respective color toner images on the photosensitive drums are sequentially superimposed and transferred onto the intermediate transfer belt 31 and a color toner image is formed on the intermediate transfer belt 31. It is noted that the toner left on the photosensitive drums 11 after the transfer is removed and recovered by the cleaner 15 to be ready for a next image forming operation.

Still further, in parallel with this toner image forming operation, the sheet P stored in the sheet feeding cassette 20 is fed one by one by a pickup roller 20a of the sheet feeding apparatus 104. The sheet P is conveyed to a registration roller pair 23 of a registration unit 21 from a fed sheet drawing roller pair 24 through a pre-registration roller pair 22.

The sheet P conveyed to the registration roller pair 23 is subjected to skew correction by forming a loop following a front end of the sheet a nip of the registration roller pair 23 and is then conveyed by the registration roller pair 23 to the secondary transfer portion while synchronizing with the toner image on the intermediate transfer belt 31. Then, the color toner image on the intermediate transfer belt 31 is transferred onto the sheet P as electrostatic load bias is applied to the secondary transfer outer roller 35 at the secondary transfer portion. It is noted that after the transfer, the toner left on the intermediate transfer belt 31 is removed and recovered by a transfer cleaner 36 to be ready for a next image forming operation.

Next, the sheet P on which the toner image has been transferred is conveyed to the fixing portion 40 so that the transferred toner image is fixed onto the sheet P by being subject to heat and pressure in passing through the fixing portion 40. Then, the sheet P on which the toner image has been fixed passes through the inner sheet discharging roller pairs 42 and 43 and is discharged by the sheet discharging roller pair 41 onto a sheet discharge tray 50 forming a bottom surface of the sheet discharging space S.

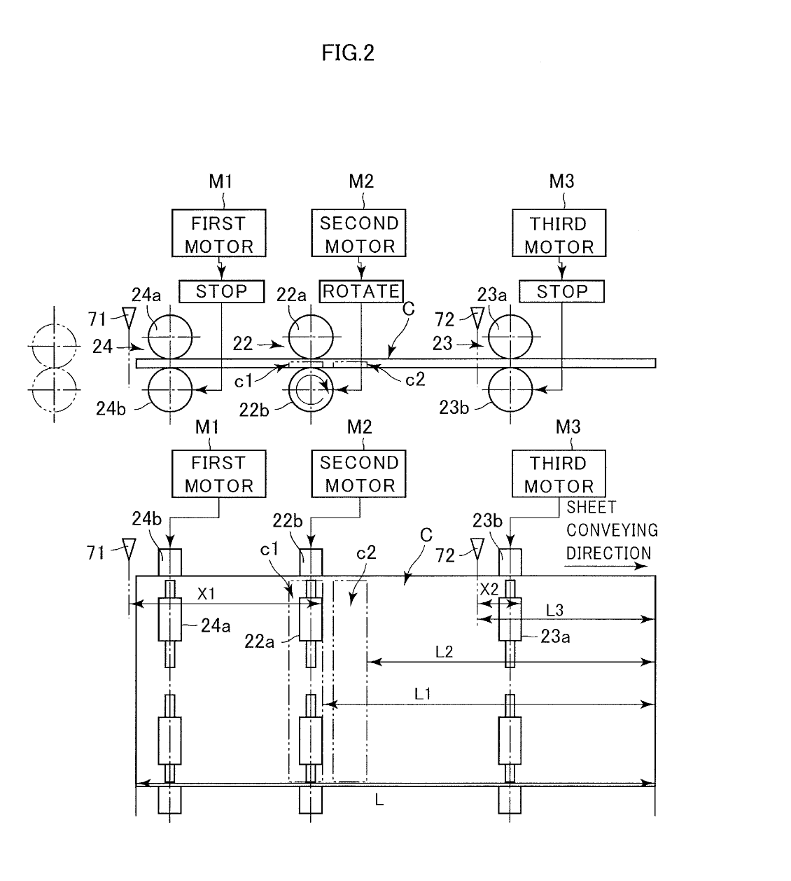

By the way, the present embodiment is arranged such that a cleaning sheet is conveyed within the printer body 101 after forming images onto a predetermined number of sheets for example. This cleaning sheet is used to continuously remove foreign matters such as paper dust adhering on surfaces of predetermined conveying roller pairs, among a plurality of conveying roller pairs provided along a sheet conveying direction of the sheet conveying apparatus 105, such as the pre-registration roller pair 22 and the registration roller pair 23 shown in FIG. 2.

Next, a cleaning operation of the surfaces of the pre-registration roller pair 22 and the registration roller pair 23 performed by the cleaning sheet of the present embodiment will be described. In FIG. 2, C denotes the cleaning sheet, c1 denotes a first cleaning region of the cleaning sheet C cleaning the surface of the pre-registration roller pair 22, and c2 denotes a second cleaning region of the cleaning sheet C cleaning the surface of the registration roller pair 23. It is noted that while an ordinary non-woven cloth such as felt is used for the cleaning sheet C in the present embodiment, fibers composing the material of the cleaning sheet C is not specifically limited as long as such material enables to reliably remove foreign matters such as paper dust adhering on the surface of the pre-registration roller pair 22 and the registration roller pair 23.

Still further, in FIG. 2, L denotes a length of the cleaning sheet C in the conveying direction thereof, L1 denotes a length from a front end in the conveying direction of the cleaning sheet C to the first cleaning region c1, and L2 denotes a length from the front end in the conveying direction of the cleaning sheet C to the second cleaning region c2. Here, the length L of the cleaning sheet C is set to be at least longer than a distance between the fed sheet drawing roller pair 24, i.e., a first conveying roller pair, and the registration roller pair 23, i.e., a second conveying roller pair, provided downstream in the sheet conveying direction of the fed sheet drawing roller pair 24. This arrangement makes it possible to hold the cleaning sheet C by the fed sheet drawing roller pair 24 and the registration roller pair 23 by stopping the fed sheet drawing roller pair 24 and the registration roller pair 23, i.e., a third conveying roller pair in cleaning the pre-registration roller pair 22 as described later.

Provided along a sheet conveying path are first and second sheet detecting sensors 71 and 72, i.e., detecting portions, detecting passage of the front end of the sheet. Here, non-contact type sensors detecting the sheet P and the cleaning sheet C directly by reflection of light are used for the first and second sheet detecting sensors 71 and 72 in the present embodiment. However, as the first and second sheet detecting sensors 71 and 72, it is also possible to use photo interrupter type sensors detecting passage of the front end of the cleaning sheet C that falls down a mechanical flag provided in the sheet conveying path and blocks a sensor light.

A driving roller 24b composing the fed sheet drawing roller pair 24 is driven by a first motor M1, i.e., a first driving portion, and rotates clockwise (CW). Then, along with the rotation of the driving roller 24b, a driven roller 24a in pressure contact with the driving roller 24b is driven and rotates counterclockwise (CCW). A driving roller 22b composing the pre-registration roller pair 22 is driven by a second motor M2, i.e., a second driving portion, and rotates clockwise. Along with that, a driven roller 22a in pressure contact with the driving roller 22b is driven.

A driving roller 23b composing the registration roller pair 23 is driven by a third motor M3, i.e., a third driving portion, and rotates clockwise. Along with that, a driven roller 23a in pressure contact with the driving roller 23b is driven. It is noted that in the present embodiment, stepping motors are used as the first through third motors M1 through M3.

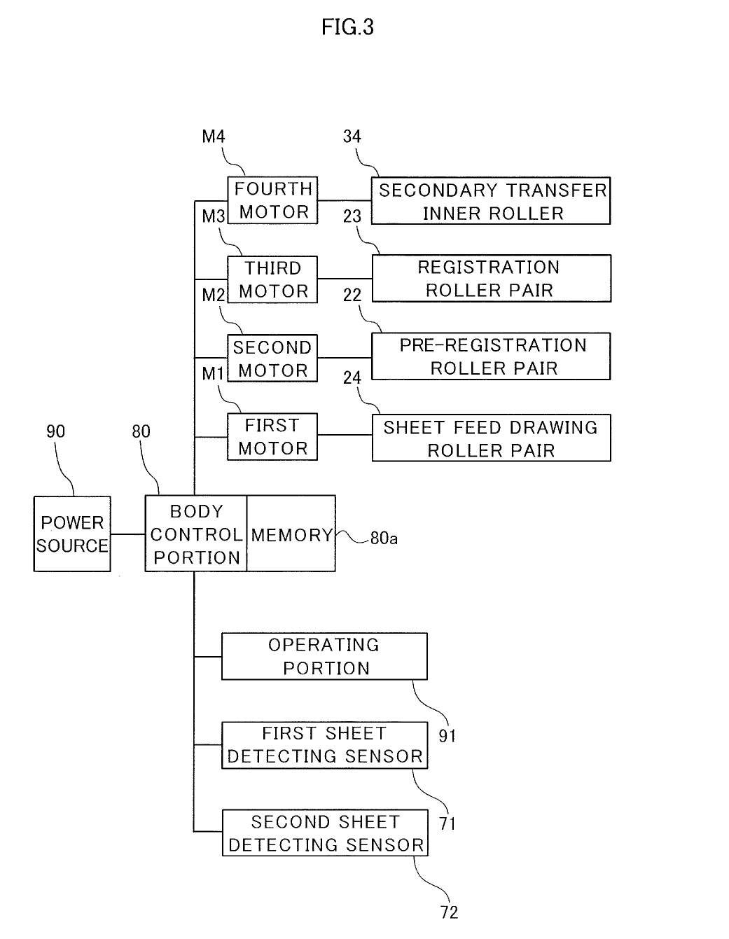

As shown in FIG. 3, the first through third motors M1 through M3 and the first and second sheet detecting sensors 71 and 72 are connected to a body control portion 80. Connected with the body control portion 80 are a power source 90, an operating portion 91, and a fourth motor M4 driving the secondary transfer inner roller 34 provided downstream in the sheet conveying direction of the registration roller pair 23. Then, the body control portion 80 drives the first through fourth motors M1 through M4 based on signals receiving from the first and second sheet detecting sensors 71 and 72. If a user sets a cleaning mode from the operating portion 91, the body control portion 80 cleans the pre-registration roller pair 22 and others by driving the pre-registration roller pair 22 and others by a program stored in a memory 80a, i.e., a storage portion.

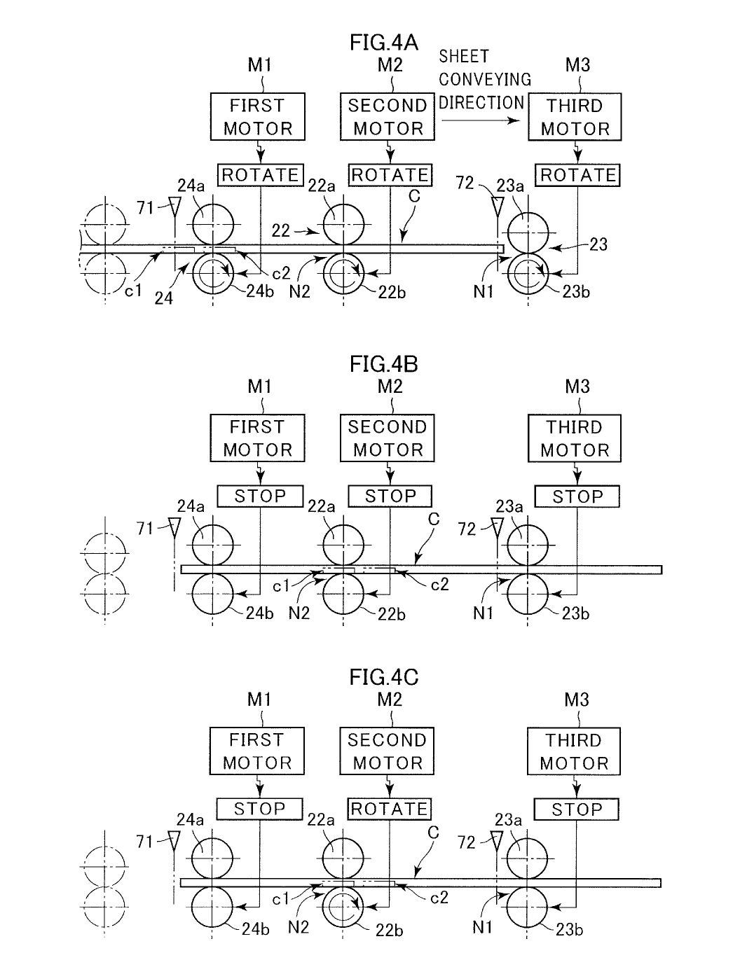

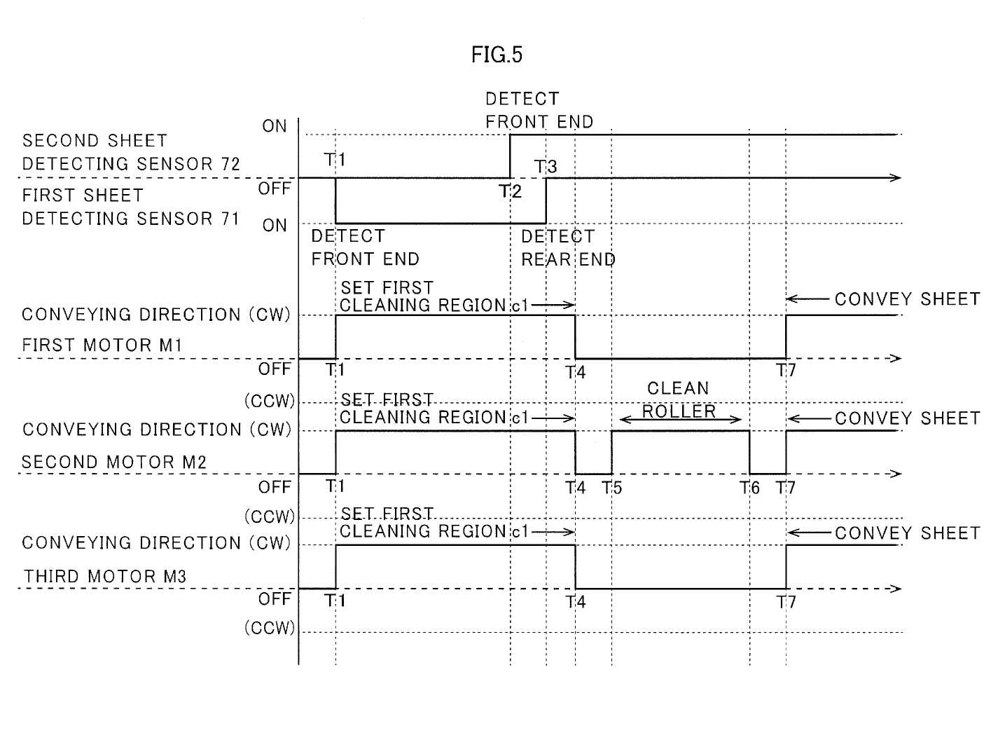

Next, the cleaning operation of the pre-registration roller pair 22 by means of the cleaning sheet C will be described. FIG. 4A is a diagram illustrating a state before the first cleaning region c1 of the cleaning sheet C arrives at a nip portion N2 of the pre-registration roller pair 22, and FIG. 4B is a diagram illustrating a state in which the first cleaning region c1 of the cleaning sheet C has arrived at the nip portion N2 of the pre-registration roller pair 22. FIG. 4C is a diagram illustrating a state in which the cleaning is performed on the pre-registration roller pair 22 by the first cleaning region c1 of the cleaning sheet C. Still further, FIG. 5 is a timing chart showing control sequence of the first through third motors M1 through M3 in moving the first cleaning region c1 of the cleaning sheet C to the nip portion N2 of the pre-registration roller pair 22 and in cleaning the pre-registration roller pair 22.

In cleaning the pre-registration roller pair 22, the cleaning sheet C is set in the sheet feeding cassette 20 at first and is then delivered out by a pickup roller 20a. Then, in response to detection of the cleaning sheet C by the first sheet detecting sensor 71 provided upstream of the fed sheet drawing roller pair 24, the body control portion 80 drives the first through third motors M1 through M3, respectively independently as shown in FIGS. 4A and 5.

Thereby, the fed sheet drawing roller pair 24, the pre-registration roller pair 22, and the registration roller pair 23 rotate at equal speed, respectively. Then, after being conveyed to the pre-registration roller pair 22 by the fed sheet drawing roller pair 24, the cleaning sheet C is conveyed to the registration roller pair 23 by the pre-registration roller pair 22. The body control portion 80 conveys the cleaning sheet C by a distance (L1+X1) shown in FIG. 2 described above based on timing when the first sheet detecting sensor 71 detects the front end of the cleaning sheet C to move to a position where the first cleaning region c1 arrives at the nip portion N2 of the pre-registration roller pair 22.

It is noted that the first cleaning region c1 is set at a region facing the pre-registration roller pair 22 when the cleaning sheet C is conveyed by a distance longer than the distance in the sheet conveying direction between the fed sheet drawing roller pair 24 and the pre-registration roller pair 22 after when the cleaning sheet C has reached the fed sheet drawing roller pair 24. Still further, the second cleaning region c2 is set at a region facing the registration roller pair 23 when the cleaning sheet C is conveyed by a distance longer than the distance in the sheet conveying direction between the fed sheet drawing roller pair 24 and the registration roller pair 23 after when the cleaning sheet C has reached the fed sheet drawing roller pair 24.

An arrangement is set such that in response to the arrival of the first cleaning region c1 of the cleaning sheet C to the nip portion N2 of the pre-registration roller pair 22, the rear end of the cleaning sheet C is nipped by the fed sheet drawing roller pair 24. Still further, the body control portion 80 drives the first through third motors M1 through M3 for a time (T4−T1) as shown in FIG. 5 to convey the cleaning sheet C by the distance (L1+X1).

In response to the arrival of the first cleaning region c1 of the cleaning sheet C to the nip portion N2 of the pre-registration roller pair 22, i.e., when the first cleaning region c1 is set at a position for cleaning the pre-registration roller pair 22, the body control portion 80 stops the first through third motors M1 through M3 as shown in FIG. 4B. After that, the body control portion 80 drives only the second motor M2 for a first predetermined time as shown in FIG. 4C. Here, the front end portion of the cleaning sheet C is held by the registration roller pair 23 being kept stopped. Still further, the rear end portion of the cleaning sheet C is being kept nipped by the fed sheet drawing roller pair 24 as described above, so that the cleaning sheet is held by the fed sheet drawing roller pair 24 being kept stopped. Thereby, if the pre-registration roller pair 22 is rotated, the driving roller 22b of the pre-registration roller pair 22 slips on the first cleaning region c1 of the cleaning sheet C. Then, the body control portion 80 cleans the surface of the driving roller 22b by causing the driving roller 22b to slip as described above.

The first predetermined time for driving the second motor M2 at this time, i.e., a roller cleaning time, is a time period (T6−T5) programmed in advance in a control sequence as shown in FIG. 5. It is noted that because the driving roller 22b is formed of a high frictional member such as rubber in the present embodiment, the apparent coefficient of friction drops if foreign matters such as paper dust adhere on the surface of the roller as described above. However, because the driven roller 22a is formed of a resin roller whose surface is smooth in general, the apparent coefficient of friction hardly drops even if foreign matters adhere thereon. Therefore, the surface of the driving roller 22b is cleaned by the cleaning sheet C in the present embodiment. Then, when the roller cleaning time elapses and the cleaning operation of the pre-registration roller pair 22 ends, the body control portion 80 stops the second motor M2 for a time (T7−T6) as shown in FIG. 5 and then drives the first through third motors M1 through M3 to convey the cleaning sheet C to the second transfer portion.

Thus, the body control portion 80 stops the first through third motors M1 through M3 at the timing when the first cleaning region c1 arrives at the nip portion N2 of the pre-registration roller pair 22 based on the detected timing of the first sheet detecting sensor 71 in cleaning the pre-registration roller pair 22. Then, the body control portion 80 drives the second motor M2 to clean the pre-registration roller pair 22.

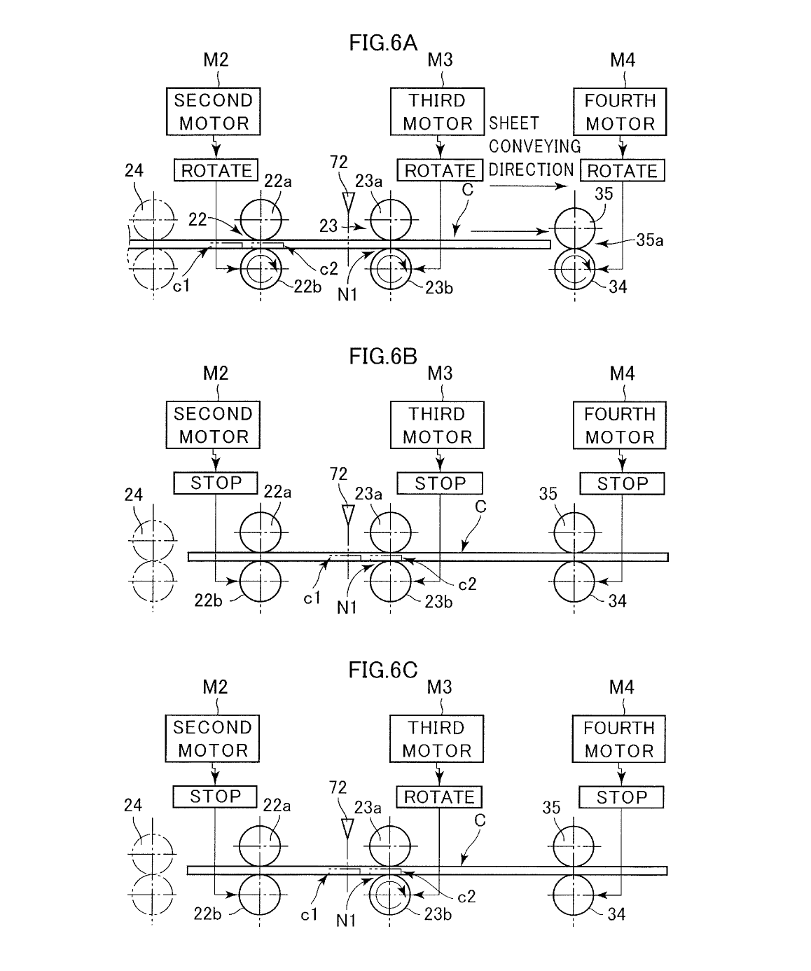

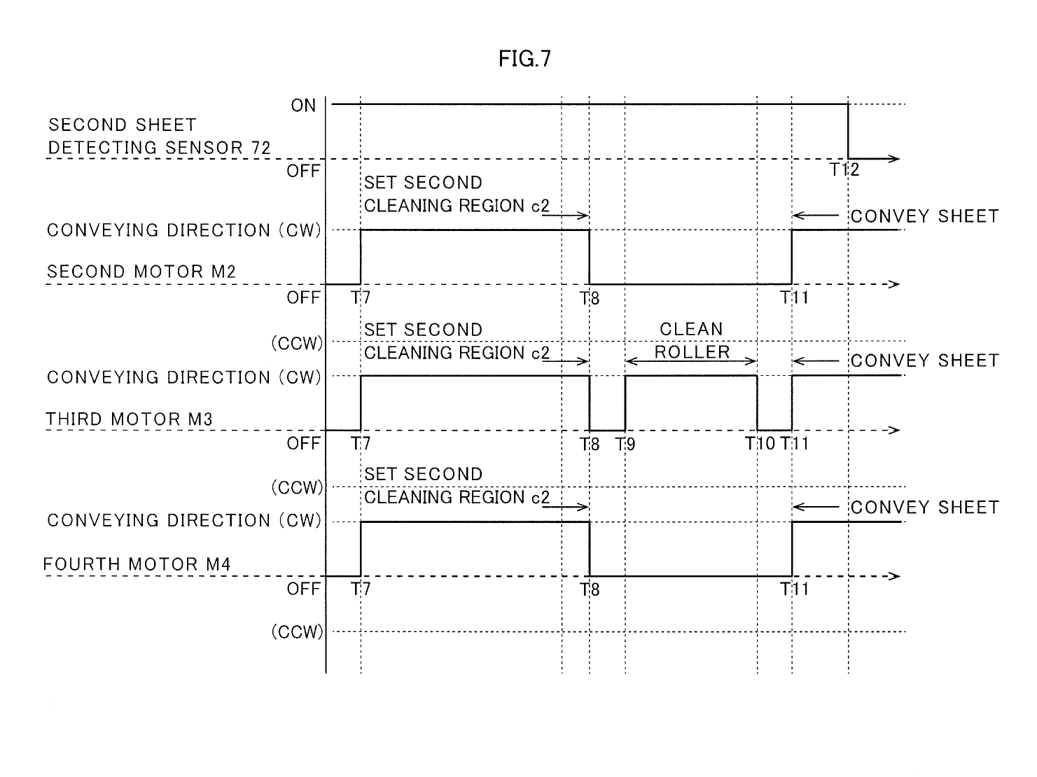

Next, a cleaning operation of the registration roller pair 23 by means of the cleaning sheet C will be described. FIG. 6A is a diagram illustrating a state before the second cleaning region c2 of the cleaning sheet C arrives at the nip portion N1 of the registration roller pair 23, and FIG. 6B is a diagram illustrating a state in which the second cleaning region c2 of the cleaning sheet C has arrived at the nip portion N1 of the registration roller pair 23. FIG. 6C is a diagram illustrating a state in which the cleaning operation is performed on the registration roller pair 23 by the second cleaning region c2 of the cleaning sheet C. Still further, FIG. 7 is a timing chart showing control sequences of the second through fourth motors M2 through M4 in moving the second cleaning region c2 of the cleaning sheet C to the nip portion N1 of the registration roller pair 23 and in cleaning the registration roller pair 23.

Here, in the present embodiment, an arrangement is made such that the registration roller pair 23 is cleaned by the cleaning sheet C successively from the cleaning operation of the pre-registration roller pair 22. It is noted that in cleaning the registration roller pair 23, the front end portion of the cleaning sheet C is held by a secondary transfer outer roller 35 being kept stopped. Due to that, the length L of the cleaning sheet C shown in FIG. 2 is set to be longer than a conveying length, whichever is longer, when the conveying length between the fed sheet drawing roller pair 24 and the pre-registration roller pair is compared with a conveying length between the pre-registration roller pair 22 and the secondary transfer roller pair 35a. This arrangement makes it possible to hold the cleaning sheet C by the pre-registration roller pair 22 and the secondary transfer roller pair 35a in cleaning the registration roller pair 23 by setting the length L of the cleaning sheet C as described above.

In response to the end of the cleaning operation of the pre-registration roller pair 22, the body control portion 80 drives the second through fourth motors M2 through M4 respectively independently as shown in FIGS. 6A and 7. Here, in driving the second through fourth motors M2 through M4, the body control portion 80 calculates a front end projecting amount L3 of the cleaning sheet C downstream of the registration roller pair 23 as shown in FIG. 2 by a signal from the second sheet detecting sensor 72 provided upstream of the registration roller pair 23. It is noted that this front end projecting amount L3 is an amount by which the front end portion of the cleaning sheet C can reach the secondary transfer roller pair 35a.

Then, based on this front end projecting amount L3, the body control portion 80 conveys the cleaning sheet C by a distance (L2−L3+X2) shown in FIG. 2 to move the second cleaning region c2 of the cleaning sheet C to a position in contact with the registration roller pair 23. It is noted that the second cleaning region c2 of the cleaning sheet C is provided to be set at a position where the rear end portion of the cleaning sheet C is nipped by the pre-registration roller pair 22 when the second cleaning region c2 arrives at the nip portion N1 of the registration roller pair 23.

Still further, after conveying the cleaning sheet C by the distance (L2−L3+X2), the body control portion 80 stops the second through fourth motors M2 through M4 as shown in FIG. 6C and drives only the third motor M3. At this time, the front end portion of the cleaning sheet C is held by the secondary transfer roller pair 35a being kept stopped, and the rear end portion of the cleaning sheet C is held by the pre-registration roller pair 22 being kept stopped. Thereby, if the registration roller pair 23 is rotated, the driving roller 23b of the registration roller pair 23 slips on the second cleaning region c2 of the cleaning sheet C. Thus, the surface of the driving roller 23b is cleaned by causing the driving roller 23b to slip.

At this time, a second predetermined time for driving the third motor M3, i.e., a roller cleaning time, is a time period of (T10−T9) programmed in advance in control sequences as shown in FIG. 7. It is noted that because the driving roller 23b is formed of a high frictional member such as rubber in the present embodiment, the apparent coefficient of friction drops if foreign matters such as paper dust adhere on the surface of the roller as described above. However, because the driven roller 23a is formed of a resin roller whose surface is smooth in general, the apparent coefficient of friction hardly drops even if foreign matters adhere thereon. Therefore, the surface of the driving roller 23b is cleaned by means of the cleaning sheet C in the present embodiment.

Then, as the roller cleaning time elapses and the cleaning operation of the registration roller pair 23 ends, the body control portion 80 stops the third motor M3 for a time (T11−T10) as shown in FIG. 7 and then drives the second through fourth motors M2 through M4 to convey the cleaning sheet C.

As described above, in cleaning the registration roller pair 23, the body control portion 80 stops the drive of the second through fourth motors M2 through M4 at the timing when the second cleaning region c2 of the cleaning sheet C arrives to the nip portion N1 of the registration roller pair 23. Then, the body control portion 80 drives the third motor M3 to clean the registration roller pair 23. It is noted that in a case of cleaning the secondary transfer roller pair 35a after that, the body control portion 80 controls the second through fourth motors M2 through M4 and others based on signals from the first and second sheet detecting sensors 71 and 72 such that the secondary transfer roller pair 35a is cleaned by a region other than the first and second cleaning regions c1 and c2.

Thus, according to the present embodiment, the body control portion 80 stops the registration roller pair 23 and the fed sheet drawing roller pair 24 and rotates only the pre-registration roller pair 22 for the first predetermined time in response to the arrival of the first cleaning region c1 of the cleaning sheet C to the pre-registration roller pair 22. This arrangement makes it possible to clean the surface of the driving roller 22b of the pre-registration roller pair 22.

Still further, after the elapse of the first predetermined time, the body control portion 80 stops the pre-registration roller pair 22 and the secondary transfer roller pair 35a and rotates only the registration roller pair 23 for the second predetermined time in response to the arrival of the second cleaning region c2 of the cleaning sheet C being conveyed to the nip portion N1 of the registration roller pair 23. This arrangement makes it possible to clean the surface of the driving roller 23b of the registration roller pair 23 located downstream of the pre-registration roller pair 22 by the second cleaning region c2.

Then, it is possible to prevent the foreign matters of the pre-registration roller pair 22 removed by the cleaning sheet C from adhering again to the registration roller pair 23 by cleaning the registration roller pair 23 by the second cleaning region c2 different from the first cleaning region c1. Still further, because it is possible to clean the roller pair without considering a rotation direction thereof even if the roller pair includes an one-way clutch by stopping at least an upstream roller pair of the roller pair to be cleaned, it becomes easy to control in cleaning the roller pairs.

It is noted that while the upstream and downstream roller pairs are stopped to cause the driving roller 22b of the pre-registration roller pair 22 and the driving roller 23b of the registration roller pair 23 to slip in the present embodiment, the present invention is not limited to such arrangement. For instance, the body control portion 80 may control such that a sheet conveying speed of the pre-registration roller pair 22 and the registration roller pair 23 is faster at least than a sheet conveying speed of upstream roller pair as far as it is possible to cause the pre-registration roller pair 22 and the registration roller pair 23 to slip.

That is, the control portion executes a cleaning mode by rotating the second conveying roller pair (the pre-registration roller pair 22) at first with a first sheet conveying speed which is faster than a sheet conveying speed of the first conveying roller pair (the fed-sheet drawing roller pair 24), conveying the sheet by the second conveying roller pair by a sheet conveying distance by which a region of the sheet that has passed through the nip portion of the second conveying roller pair when the second conveying roller pair rotates with the first sheet conveying speed is located at a position different in the sheet conveying direction from the nip portion of the third conveying roller pair (the registration roller pair 23) after rotating the second conveying roller pair with the first speed, and then rotating the third conveying roller pair with a second sheet conveying speed faster than the sheet conveying speed of the second conveying roller pair.

Here, the distance by which the sheet conveying distance region of the sheet that has passed through the second conveying roller pair is located at the position different from the nip portion of the third conveying roller pair is set to be shorter than a distance set such that a length of the region of the sheet that has passed through the nip portion of the second conveying roller pair while the second conveying roller pair rotates at the first speed is subtracted from the distance between the nip portions of the second and third conveying roller pairs. Or, the sheet conveying distance by which the region of the sheet that has passed through the second conveying roller pair is located at the position different from the nip portion of the third conveying roller pair is set to be longer than a distance in which the length of the region of the sheet that has passed through the second conveying roller pair while the second conveying roller pair rotates at the first speed is added to the distance between the nip portions of the second and third conveying roller pairs.

It is noted that the distance, by which the region of the sheet is located at the position different from the nip portion of the third conveying roller pair, is set to be shorter than the distance in which the length of the region of the sheet that has passed through the nip portion of the second conveying roller pair is subtracted from the distance between the nip portions of the second and third conveying roller pairs in the first embodiment. Meanwhile, in order to avoid the region of the sheet that has passed through the nip portion of the second conveying roller pair from passing through the nip portion of the third conveying roller pair after cleaning up the third conveying roller pair, the sheet conveying distance may be set to be longer than the distance set such that the length of the region of the sheet that has passed through the second conveying roller pair is added to the distance between the nip portions of the second and third conveying roller pairs.

It is also possible to control to stop at least the roller pair located upstream of the pre-registration roller pair 22 and the registration roller pair 23 without stopping the both upstream and downstream roller pairs. That is, it is also possible to stop the drive of the first conveying roller pair by the first driving portion in rotating the second conveying roller pair with the first sheet conveying speed and to stop the drive of the second conveying roller pair by the second driving portion in rotating the third conveying roller pair with the second sheet conveying speed. This arrangement makes it possible to cause the pre-registration roller pair 22 and the registration roller pair 23 to slip.

Still further, while the operation in cleaning the roller pair disposed upstream in the sheet conveying direction of the secondary transfer roller pair 35a has been described in the present embodiment, this is applicable also to a case of cleaning a roller pair disposed downstream in the sheet conveying direction of the secondary transfer roller pair 35a. It is noted that in this case, a cleaning region is changed through the operating portion 91 corresponding to a number of conveying roller pairs to be cleaned and to a layout of the conveying roller pair.

### Second Embodiment

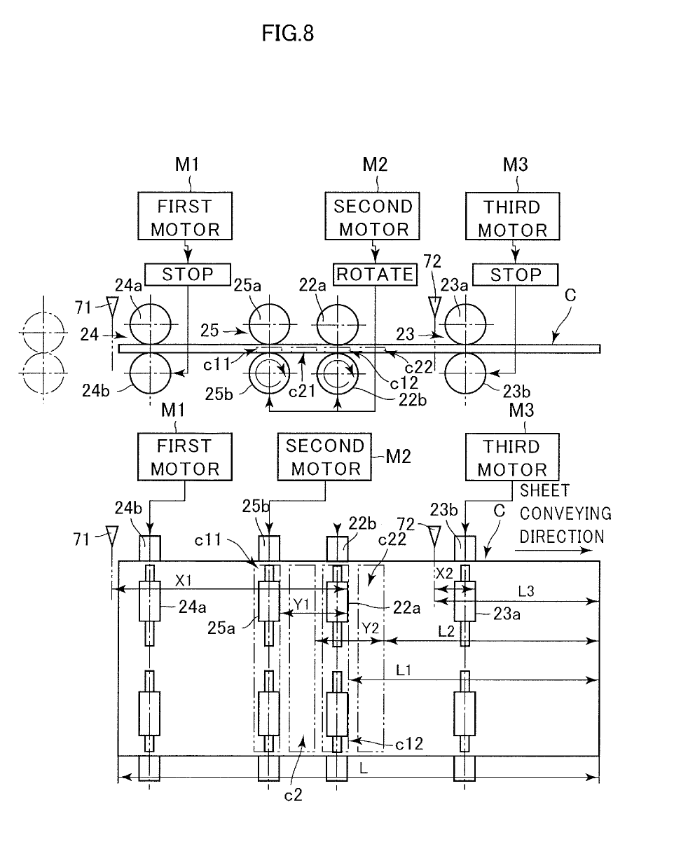

Next, a second embodiment of the invention will be described below. FIG. 8 is a diagram illustrating a cleaning operation of a sheet conveying apparatus of the present embodiment. It is noted that in FIG. 8, the same reference numerals with those in FIG. 2 described above denote the same or corresponding components of the first embodiment. A conveying roller pair 25, i.e., a fourth conveying roller pair, shown in FIG. 8 is provided near the pre-registration roller pair 22 and is driven by the second motor M2, i.e., the same driving source with that of the pre-registration roller pair 22. It is noted that in the present embodiment, the conveying roller pair 25 is provided at a position distant by a distance Y1 upstream of the pre-registration roller pair 22.

Here, in the present embodiment, the first cleaning region c1 of the cleaning sheet C is composed of an upstream region c11 cleaning a surface of the conveying roller pair 25 and a downstream region c12 cleaning the surface of the pre-registration roller pair 22. Still further, according to the present embodiment, the second cleaning region c2 of the cleaning sheet C is composed of an upstream region c21 located between the upstream region c11 and the downstream region c12 of the first cleaning region c1 and a downstream region c22 located downstream of the downstream region c12. Then, in a case of cleaning the pre-registration roller pair 22, the cleaning sheet C is set at first in the sheet feeding cassette 20 and is delivered by the pickup roller 20a. Then, as the first sheet detecting sensor 71 detects the cleaning sheet C, the body control portion 80 drives the first through third motors M1 through M3 respectively independently.

Then, after being conveyed to the pre-registration roller pair 22 by the fed sheet drawing roller pair 24, the cleaning sheet C is conveyed to the registration roller pair 23 by the pre-registration roller pair 22. It is noted that the body control portion 80 conveys the cleaning sheet C by the distance (L1 +X1) based on timing when the first sheet detecting sensor 71 detects the front end of the cleaning sheet C. Here, the upstream region c11 of the first cleaning region c1 is set to move to a position being into contact with the conveying roller pair 25 when the downstream region c12 moves to a position being into contact with the pre-registration roller pair 22. Therefore, when the cleaning sheet C is conveyed by the distance (L1+X1), the upstream region c11 of the first cleaning region c1 of the cleaning sheet C moves to the position being into contact with the conveying roller pair 25 and the downstream region c12 to the position being into contact with the pre-registration roller pair 22.

Next, when the first cleaning region c1 of the cleaning sheet C comes into a state of arriving at the conveying roller pair 25 and the pre-registration roller pair 22, the body control portion 80 stops the first through third motors M1 through M3 and then drives only the second motor M2 for the first predetermined time. Thereby, the conveying roller pair 25b of the conveying roller pair 25 and the driving roller 22b of the pre-registration roller pair 22 slip on the first cleaning region c1 of the cleaning sheet C.

Then, it is possible to clean the surfaces of the driving rollers 22b and 25b at the same time by causing the driving rollers 22b and 25b to slip as described above. It is noted that the driving time of the second motor M2 at this time, i.e., a roller cleaning time, is a time period programmed in advance in the control sequence. Then, as the roller cleaning time elapses and the cleaning operation of the conveying roller pair 25 and the pre-registration roller pair 22 ends, the body control portion 80 stops the second motor M2 and then drives the first through third motors M1 through M3 to convey the cleaning sheet C to the secondary transfer portion.

As described above, the body control portion 80 stops to drive the first through third motors M1 through M3 at the timing when the first cleaning region c1 of the cleaning sheet C arrives at the pre-registration roller pair 22 and the conveying roller pair 25 in cleaning the pre-registration roller pair 22 and the conveying roller pair 25. Subsequently, the body control portion 80 drives the second motor M2 for the first predetermined time to clean the pre-registration roller pair 22 and the conveying roller pair 25.

Then, in a case of cleaning the registration roller pair 23 in succession, the body control portion 80 controls the conveyance of the cleaning sheet C to clean the registration roller pair 23 by the upstream region c21 or the downstream region c22 of the cleaning region c2 other than the first cleaning region c1 of the cleaning sheet C. That is, the body control portion 80 drives the first through third motors M1 through M3 such that the upstream region c21 or the downstream region c22 of the second cleaning region c2 arrives at the registration roller pair 23 and conveys the cleaning sheet C by a distance (L2−L3+X2) or a distance (L2−L3+X2+Y2). Then, the registration roller pair 23 is cleaned by the same sequence with that of the first embodiment as described above.

As described above, in the case of cleaning the pre-registration roller pair 22 and the conveying roller pair 25 driven by the second motor M2, i.e., the same driving source, like the present embodiment, the pre-registration roller pair 22 and the conveying roller pair 25 are cleaned by the first cleaning region c1. Then, it is possible to prevent the foreign matters on the pre-registration roller pair 22 and the conveying roller pair 25 which have been removed by the cleaning sheet C from adhering again on the registration roller pair 23 by cleaning the registration roller pair 23 by the second cleaning region c2. It is noted that while the second cleaning region c2 is composed of the upstream region c21 and the downstream region c22 in the present embodiment, the second cleaning region c2 may be composed of at least one of the upstream region c21 and the downstream region c22.

While the upstream and downstream roller pairs are stopped to cause the driving roller 22b of the pre-registration roller pair 22 and the driving roller 23b of the registration roller pair 23 to slip in the present embodiment, the present invention is not limited to such arrangement. For instance, it is also possible to control such that a sheet conveying speed of the pre-registration roller pair 22 and the registration roller pair 23 is at least faster than a sheet conveying speed of the upstream roller pair as long as it is possible to cause the pre-registration roller pair 22 and the registration roller pair 23 to slip.

In a case of this cleaning mode, the sheet is nipped by the conveying roller pair 25, the fed sheet drawing roller pair 24, i.e., the conveying roller pair upstream of the conveying roller pair 25, and the pre-registration roller pair 22, i.e., the conveying roller pair downstream of the conveying roller pair 25. Then, in the state in which the sheet is nipped, the conveying roller pair 25 and the pre-registration roller pair 22 are rotated in synchronism with a sheet conveying speed faster than a sheet conveying speed of the fed sheet drawing roller pair 24.

### Third Embodiment

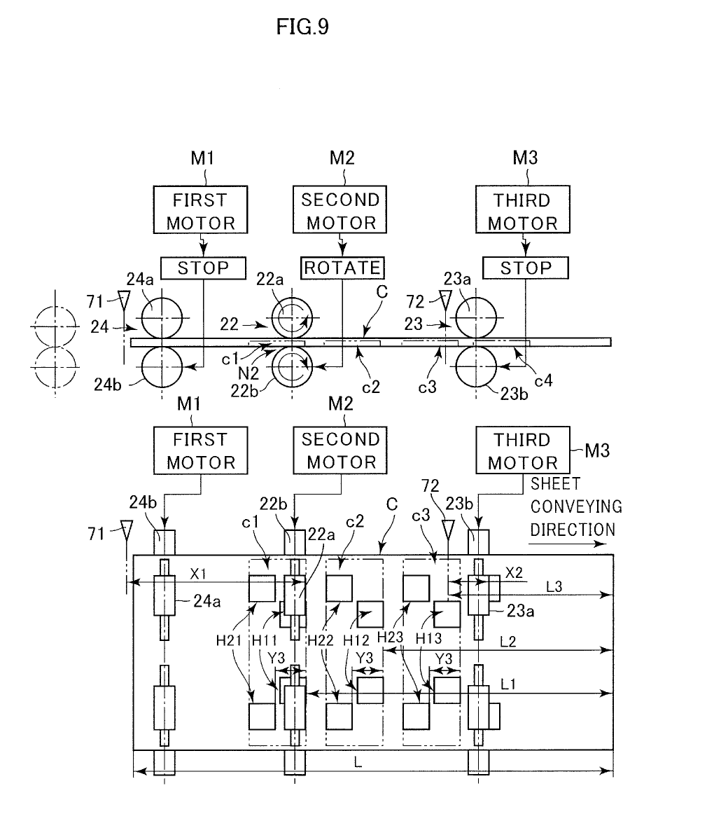

Next, a third embodiment of the invention will be described below. FIG. 9 is a diagram illustrating a cleaning operation of a sheet conveying apparatus of the present embodiment. It is noted that in FIG. 9, the same reference numerals with those in FIG. 2 described above denote the same or corresponding components of the first embodiment. As shown in FIG. 9, the cleaning sheet C is provided with a third cleaning region c3 cleaning the transfer roller pair 35a. Still further, the first cleaning region c1 of the cleaning sheet C is provided with first and second cleaning sheet holes H11 and H21 formed there through. First and second cleaning sheet holes H12 and H22 are also formed through the second cleaning region c2 of the cleaning sheet C, and first and second cleaning sheet holes H13 and H23 are formed through the third cleaning region c3 of the cleaning sheet C.

Here, the first cleaning sheet holes H11 through H13, i.e., first openings, and the second cleaning sheet holes H21 through H23, i.e., second openings, are formed into rectangular shapes, respectively, and are disposed in zigzags while being separated by a distance (Y3) in the sheet conveying direction. It is noted that according to the present embodiment, the second cleaning sheet holes H21 through H23 provided downstream in the sheet conveying direction of the first cleaning sheet holes H11 through H13 are formed so as not to overlap with the first cleaning sheet holes H11 through H13 in a width direction orthogonal to the sheet conveying direction. However, the shapes and array patterns of the first cleaning sheet holes H11 through H13 and the second cleaning sheet holes H21 through H23 may be set corresponding to a configuration of the conveying roller.

Then, it is possible to bring the driving roller into contact partially with the driven roller in cleaning the rollers by disposing the first cleaning sheet holes H11 through H13 and the second cleaning sheet holes H21 through H23 in the respective cleaning regions c1 through c3 of the cleaning sheet C as described above. This arrangement makes it possible to cause the driven roller to slip while being in contact with the cleaning sheet C and to clean the driven roller by driving the driving rollerside when the driving roller rotates while slipping in cleaning the roller.

In cleaning the pre-registration roller pair 22 by the cleaning sheet C through which the first and second cleaning sheet holes H11 through H13 and H21 through H23 are formed, the cleaning sheet C set within the sheet feeding cassette 20 is delivered out by the pickup roller 20a at first. Then, as the first sheet detecting sensor 71 detects the cleaning sheet C, the body control portion 80 drives the first through third motors M1 through M3 respectively independently.

Thereby, the cleaning sheet C is conveyed to the pre-registration roller pair 22 by the fed sheet drawing roller pair 24, and is then conveyed to the registration roller pair 23 by the pre-registration roller pair 22. It is noted that the body control portion 80 conveys the cleaning sheet C by the distance (L1+X1) based on the timing when the first sheet detecting sensor 71 detects the front end of the cleaning sheet C. Thereby, the first cleaning sheet holes H11 of the first cleaning region c1 of the cleaning sheet C moves to the nip portion N2 of the pre-registration roller pair 22 as shown in FIG. 9.

Next, when the first cleaning sheet hole H11 arrives at the nip portion N2 of the pre-registration roller pair 22, the body control portion 80 stops the first through third motors M1 through M3 and then drives only the second motor M2 for the first predetermined time. Here, when the first cleaning sheet hole H11 is moved to the nip portion N2 of the pre-registration roller pair 22, the driving roller 22b and the driven roller 22a of the pre-registration roller pair 22 partially comes into pressure contact through the first cleaning sheet hole H11.

When the second motor M2 is driven in this state, the driven roller 22a being in pressure contact with the driving roller 22b of the pre-registration roller pair 22 at the part of the first cleaning sheet hole H11 rotates. At this time, parts of the driving roller 22b and the driven roller 22a not facing the first cleaning sheet hole H11, i.e., parts of the driving roller 22b and the driven roller 22a being in contact with the cleaning sheet C slip. Thereby, cleaning is conducted on the surfaces of these parts of the driving roller 22b and the driven roller 22a.

Next, after the elapse of the predetermined time, the body control portion 80 stops the second motor M2. Subsequently, the body control portion 80 drives the first through third motors M1 through M3 to move the cleaning sheet C by the distance (Y3) between the first and second cleaning sheet holes H11 and H21 and to move the second cleaning sheet hole H21 to the nip portion N2 of the pre-registration roller pair 22.

Next, when the second cleaning sheet hole H21 arrives at the nip portion N2 of the pre-registration roller pair 22, the body control portion 80 stops the first through third motors M1 through M3 and then to drive only the second motor M2. Here, when the second cleaning sheet hole H21 moves to such position, parts of the driving roller 22b and the driven roller 22a of the pre-registration roller pair 22 that have been nipping the cleaning sheet C come into contact at the second cleaning sheet hole H21.

Then, when the body control portion 80 drive the second motor M2 in this state, the driving roller 22b and the driven roller 22a of the pre-registration roller pair 22 rotate. It is noted that the first cleaning sheet holes H11 through H13 and the second cleaning sheet holes H21 through H23 are disposed in zigzags so that they do not overlap in the width direction. Therefore, a part of the uncleaned roller surface of the driving roller 22b and a part of the uncleaned roller surface of the driven roller 22a can be cleaned by rotating the rollers at the position of the second cleaning sheet hole H21. Next, as the roller cleaning time elapses and the cleaning of the pre-registration roller pair 22 ends, the body control portion 80 stops the second motor M2 and then drives the first through third motors M1 through M3 to convey the cleaning sheet C to the secondary transfer portion.

As described above, according to the present embodiment, the first cleaning sheet holes H11 through H13 and the second cleaning sheet holes H21 through H23 are disposed in the respective cleaning regions c1 through c3 of the cleaning sheet C. Then, the driven roller 22a is rotated by the drive of the driving roller 22b of the pre-registration roller pair 22 for example in cleaning the rollers. Thereby, the driven roller 22a and the driving roller 22b are caused to slip at the same time to clean the pre-registration roller pair 22.

That is, according to the present embodiment, the first cleaning sheet holes H11 through H13 and the second cleaning sheet holes H21 through H23 transmitting the drive from the driving roller to the driven roller are provided in the cleaning sheet C to cause the driven roller to slip together with the driving roller on the cleaning sheet C. This arrangement makes it possible to clean not only the driving roller but also the driven roller by the cleaning sheet C.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2014-162456, filed on Aug. 8, 2014 and 2015-151150, filed on Jul. 30, 2015, which are hereby incorporated by reference herein in their entirety.

What is claimed is:

1. A sheet conveying apparatus, comprising:
a first conveying roller pair driven by a first driving portion;
a second conveying roller pair provided downstream, in the sheet conveying direction, of the first conveying roller pair and driven by a second driving portion;
a third conveying roller pair provided downstream, in a sheet conveying direction, of the second conveying roller pair and driven by a third driving portion;
a cleaning sheet including a first cleaning region for cleaning the second conveying roller pair and a second cleaning region, different from the first cleaning region, for cleaning the third conveying roller pair;
a control portion controlling the first, second and third driving portions, the control portion controlling the first and second driving portions such that a sheet conveying speed of the second conveying roller pair is faster than a sheet conveying speed of the first conveying roller pair for a first predetermined time, in response to an arrival of the first cleaning region of the cleaning sheet being conveyed by the first and second conveying roller pairs to the second conveying roller pair, and controlling, after an elapse of the first predetermined time, the second and third driving portions such that a sheet conveying speed of the third conveying roller pair is faster than the sheet conveying speed of the second conveying roller pair for a second predetermined time in response to an arrival of the second cleaning region of the cleaning sheet being conveyed by the second and third conveying roller pairs to the third conveying roller pair.

2. The sheet conveying apparatus according to claim 1, wherein a length of the cleaning sheet is longer than both distances in the conveying direction between the first and the second conveying roller pairs and between the second and third conveying roller pairs.

3. The sheet conveying apparatus according to claim 1, further comprising a detection portion detecting passage of the cleaning sheet,
wherein the control portion controls the first, second, and third driving portions based on a signal from the detection portion.

4. The sheet conveying apparatus according to claim 1, further comprising a fourth conveying roller pair provided in a vicinity of the second conveying roller pair, driven by the second driving portion, and cleaned by the first cleaning region of the cleaning sheet,
wherein the control portion controls the first and second driving portions, in response to an arrival of the first cleaning region of the cleaning sheet, being conveyed by the first, second, and fourth conveying roller pairs, to the second and fourth conveying roller pairs, such that a sheet conveying speed of the second and fourth conveying roller pairs is faster than a sheet conveying speed of the first conveying roller pair.

5. The sheet conveying apparatus according to claim 1, wherein the first and second cleaning regions of the cleaning sheet are provided with first openings and second openings disposed downstream in the sheet conveying direction of the first openings not overlapping with the first openings in a width direction orthogonal to the sheet conveying direction.

6. The sheet conveying apparatus according to claim 1, wherein the control portion controls the first and second driving portions to rotate the second conveying roller pair for the first predetermined time and to stop the first conveying roller pair in cleaning the second conveying roller pair by the cleaning sheet and controls the second and third driving portions to rotate the third conveying roller pair for the second predetermined time and to stop the second conveying roller pair in cleaning the third conveying roller pair by the cleaning sheet.

7. A sheet conveying apparatus, comprising:
a plurality of conveying roller pairs disposed along a sheet conveying direction;
a plurality of driving portions driving the plurality of conveying roller pairs, respectively;
a cleaning sheet cleaning the conveying roller pairs; and
a control portion controlling the plurality of driving portions such that a predetermined conveying roller pair among the plurality of conveying roller pairs is cleaned by the first cleaning region of the cleaning sheet, and then a conveying roller pair located downstream, in the sheet conveying direction, of the predetermined conveying roller pair is cleaned by a second cleaning region different from the first cleaning region of the cleaning sheet.

8. The sheet conveying apparatus according to claim 7, wherein the control portion controls the plurality of driving portions, in response to an arrival of the first cleaning region of the cleaning sheet to the predetermined conveying roller pair, such that a sheet conveying speed of the predetermined conveying roller pair is faster than a sheet conveying speed of a conveying roller pair located upstream, in the sheet conveying direction, of the predetermined conveying roller pair, and after an elapse of the first predetermined time, controls the plurality of driving portions, in response to an arrival of the second cleaning region of the cleaning sheet to the conveying roller pair located downstream of the predetermined conveying roller pair, such that a sheet conveying speed of the conveying roller pair located downstream of the predetermined conveying roller pair is faster than the sheet conveying speed of the predetermined conveying roller pair for a second predetermined time.

9. A sheet conveying apparatus, comprising:
a first conveying roller pair driven by a first driving portion;
a second conveying roller pair provided downstream, in a sheet conveying direction, of the first conveying roller pair and driven by a second driving portion;
a third conveying roller pair provided downstream, in a sheet conveying direction, of the second conveying roller pair and driven by a third driving portion;
a control portion controlling the first, second, and third driving portions, the control portion executing a cleaning mode by rotating the second conveying roller pair with a first sheet conveying speed faster than a sheet conveying speed of the first conveying roller pair, conveying the sheet by the second conveying roller pair by a sheet conveying distance by which a region of the sheet that has passed through the nip portion of the second conveying roller pair while the second conveying roller pair rotates with the first sheet conveying speed is located at a position different in the sheet conveying direction from the nip portion of the third conveying roller pair after rotating the second conveying roller pair with the first sheet conveying speed, and then rotating the third conveying roller pair with a second sheet conveying speed faster than the first sheet conveying speed of the second conveying roller pair.

10. The sheet conveying apparatus according to claim 9, wherein the control portion stops the drive of the first conveying roller pair of the first driving portion in rotating the second conveying roller pair with the first sheet conveying speed and stops the drive of the second conveying roller pair of the second driving portion in rotating the third conveying roller pair with the second sheet conveying speed.

11. The sheet conveying apparatus according to claim 9, wherein the sheet conveying distance is shorter than a distance in which a length of the region of the sheet that has passed through the nip portion of the second conveying roller pair while the second conveying roller pair rotates at the first rotating speed is subtracted from a distance between the nip portions of the second and third conveying roller pairs.

12. The sheet conveying apparatus according to claim 9, wherein the sheet conveying distance is longer than a distance in which a length of the region of the sheet that has passed through the nip portion of the second conveying roller pair while the second conveying roller pair rotates at the first rotating speed is added to a distance between the nip portions of the second and third conveying roller pairs.

13. The sheet conveying apparatus according to claim 9, further comprising a fourth conveying roller pair provided between the second and third conveying roller pairs in the sheet conveying direction and driven by the second driving portion,
wherein the control portion rotates the fourth conveying roller pair in synchronism with the second conveying roller pair with the first sheet conveying speed in the cleaning mode.

14. A sheet conveying apparatus, comprising:
a conveying roller pair; an upstream conveying roller pair provided upstream, in a sheet conveying direction, of the conveying roller pair;
a downstream conveying roller pair provided downstream, in the sheet conveying direction of the conveying roller pair; and
a control portion controlling the conveying roller pair, the upstream conveying roller pair, and the downstream conveying roller pair, the control portion executing a cleaning mode of rotating the conveying roller pair and the downstream conveying roller pair in synchronism with a sheet conveying speed faster than a sheet conveying speed of the upstream conveying roller pair in a state in which a sheet is nipped by nip portions of the conveying roller pair, the upstream conveying roller pair, and the downstream conveying roller pair.

15. An image forming apparatus, comprising:
an image forming portion forming an image on a sheet; and
a sheet conveying apparatus as set forth in claim 1 configured to convey the sheet.
